(19) United States
(12) Patent Application Publication
(10) Pub. No.: US 2021/0367386 A1
(43) Pub. Date: Nov. 25, 2021

(54) ALTERNATING CURRENT INLET UNIT

(71) Applicant: HEWLETT-PACKARD DEVELOPMENT COMPANY, L.P., HOUSTON, TX (US)

(72) Inventors: CHUN-YI LAI, TAIPEI CITY (TW); MING-FENG HSIEH, TAIPEI CITY (TW); CHIH-TING LAI, TAIPEI CITY (TW)

(21) Appl. No.: 16/325,282

(22) PCT Filed: Oct. 18, 2017
(86) PCT No.: PCT/US2017/057190

§ 371 Date: Feb. 13, 2019

(51) Int. Cl. H01R 24/70; H01R 24/68

(52) U.S. Cl. CPC H01R 24/70; H01R 2105/00; H01R 24/68

(57) ABSTRACT

The present subject matter relates to Alternating Current (AC) inlet units. An AC inlet unit includes a socket to receive a power supply cord and a ground pin and a second pin, each disposed in the socket. The AC inlet unit further includes a lead connected to the second pin. The lead is disposed farther from the ground pin as compared to the second pin.

### BACKGROUND

Alternating Current (AC) inlet units are used for connecting power supply cords to electrical appliances or electronic equipment. Examples of AC inlet units include a C14 inlet unit and a C6 inlet unit. An AC inlet unit typically includes pins, such as a ground pin, a line pin, and a neutral pin that can be connected to a power supply cord, and leads connected to the pins. The leads enable connection of the AC inlet unit to an electrical appliance or electronic equipment.

### BRIEF DESCRIPTION OF DRAWINGS

The following detailed description references the figures, wherein:

FIG. 1 illustrates a perspective view of an AC inlet unit, according to an example implementation of the present subject matter.

FIG. 2 illustrates another perspective view of the AC inlet unit, according to an example implementation of the present subject matter.

FIG. 3 illustrates pins, leads, and connectors of the AC inlet unit, according to an example implementation of the present subject matter.

FIG. 4 illustrates a power adapter, according to an example implementation of the present subject matter.

FIG. 5 illustrates a perspective view of the AC inlet unit, according to an example implementation of the present subject matter.

### DETAILED DESCRIPTION

An Alternating Current (AC) inlet unit can be used for connecting an electrical appliance or electronic equipment to a power supply. The AC inlet unit can be used, for example, in a power adapter for a computing device for receiving AC power through a power supply cord and supplying the AC power to another component in the power adapter.

An AC inlet unit may include a line pin, a neutral pin, and a ground pin, each disposed in a socket. The ground pin is generally disposed above the line pin and the neutral pin. The AC inlet unit also includes leads connected to the pins for connecting the pins to another component. In such AC inlet units, to maintain distance between the leads and the pins to comply with the safety standards, the leads are disposed above the ground pin. This causes an increase in the height of the AC inlet. Consequently, the dimensions of an equipment including the AC inlet unit, such as a power adapter, also increase.

The present subject matter relates to an Alternating Current (AC) inlet unit. With the implementations of the present subject matter, equipment, such as a power adapter, including the AC inlet unit can be made compact while also complying with safety standards.

In accordance with an example implementation, an AC inlet unit includes a socket to receive a power supply cord. The AC inlet unit also includes a ground pin and a second pin, such as a line pin or a neutral pin. The ground pin and the second pin are disposed in the socket. A lead connected to the second pin is disposed farther from the ground pin as compared to the second pin. For example, the lead connected to the second pin may be disposed near the second pin.

In a power adapter according to an example implementation, the ground pin is disposed at a greater height than the second pin. The lead connected to the second pin is disposed at a lower height than the ground pin.

In accordance with a further example implementation, the AC inlet unit includes a line pin, a neutral pin, and a ground pin. The ground pin, the line pin, and the neutral pin are displaced from each other in a first dimension, such as width, of the AC inlet unit. Further, the line pin and the neutral pin are each displaced from the ground pin in a second dimension, such as height, of the AC inlet unit. A ground lead connected to the ground pin is disposed farther from the ground pin in the first dimension than in the second dimension. For example, the ground lead may be disposed farther away from the ground pin along the width of the AC inlet unit than along the height of the AC inlet unit.

The disposal of leads of AC inlet unit according to the present subject matter enables disposal of at least one lead, such as the line lead or the neutral lead, below the ground pin and disposal of the ground lead to the side of the ground pin, rather than above the ground pin. Therefore, the present subject matter reduces the height of the AC inlet unit. This also makes the equipment including the AC inlet unit, such as the power adapter, a compact one. While being compact, the AC inlet unit and the power adapter comply with safety standards as well.

The following description refers, to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

Example implementations of the present subject matter are described with regard to AC inlet units for power adapters of computing devices. Although not described, it will be understood that the implementations of the present subject matter can be used with other equipment utilizing AC inlet units.

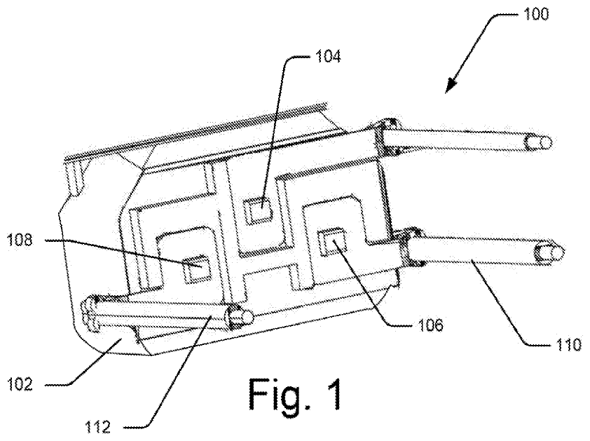

FIG. 1 illustrates a perspective view of an AC inlet unit 100 as viewed from behind a socket 102 of the AC inlet unit 100 according, to an example implementation of the present subject matter. The AC inlet unit 100 may be utilized as part of an appliance coupler that includes the AC inlet unit 100 and an AC connector (not shown in FIG. 1) and that can be used for connecting power supply cords to electrical appliances or electronic equipment.

The AC inlet unit 100 includes the socket 102 to receive a power supply cord. The AC inlet unit 100 also includes a ground pin 104 and a second pin, each disposed in the socket 102. The second pin may be, for example, a line pin 106 or a neutral pin 108. The AC inlet unit 100 further includes a lead connected to the second pin. This lead is hereinafter referred to as a second lead. The second lead may be, for example, a line lead 110, connected to the line pin 106, or the neutral lead 112, connected to the neutral pin 108. The second lead is disposed farther from the ground pin 104 as compared to the second pin. For example, the line lead 110 is nearer to the line pin 106 than to the ground pin 104. Similarly, the neutral d 112 is nearer to the neutral pin 8 than to the ground pin 104.

The distance between two entities, such as a pin and a lead, refers to the distance between their respective central axes. For example, the distance between the neutral lead 112 and the ground pin 104 is the distance between their respective central axes. The central axis of an entity may be the axis that extends along the length of the entity, as will be explained later.

The above-mentioned position of the second lead relative to the ground pin 104 and the second pin can facilitate decreasing height of the AC inlet unit 100, and can, therefore, make a device including the AC inlet unit 100 a compact one, as will be further explained below.

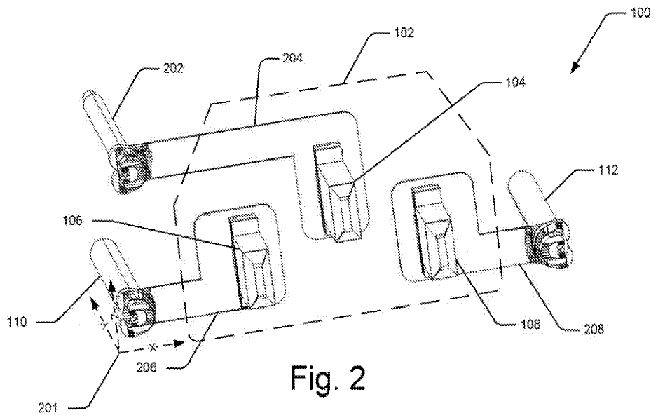

FIG. 2 illustrates another perspective view of the AC inlet unit 100, according to an example implementation of the present subject matter. Here, the socket 102 is illustrated as a transparent block and indicated by dotted lines.

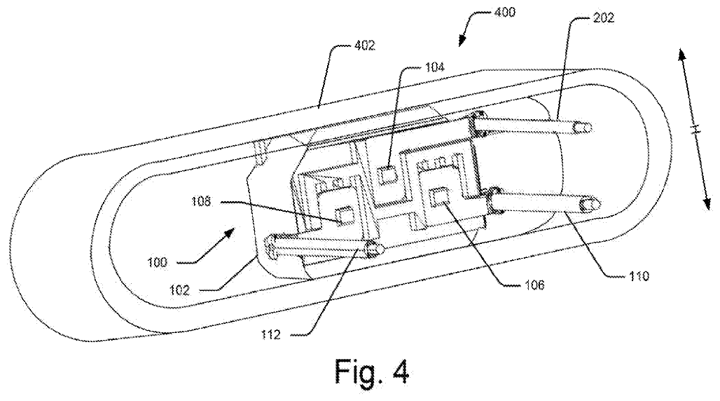

The AC inlet unit 100 may be a C14 inlet unit, which complies with the International Electrotechnical Commission (IEC) 60320 standard. Accordingly, the size of the socket 102 and the spacing between the pins, such as the vertical spacing between the ground pin 104 and the line pin 106 and the horizontal spacing between the line pin 106 and the neutral pin 108, may be as per the IEC 60320 standard. Further, the AC inlet unit 100 may be used in a power adapter for a computing device, as will be explained with reference to FIG. 4.

The socket 102 can receive a power supply cord (not shown in FIG. 2) from the front, i.e., from the side of the socket 102 away from the line lead 110 and the neutral lead 112. The power supply cord may include an AC connector corresponding to the AC inlet unit 100. For example, when the AC inlet unit 100 is a C14 inlet unit, the AC connector of the power supply cord may be a C13 connector, which can mate with the C14 inlet, to form a C13/C14 coupler.

The ground pin 104, the line pin 106, and the neutral pin 108 are disposed in the socket 102 and are displaced from each other in, the socket 102. In an example, the ground pin 104, the line pin 106, and the neutral pin 108 may be displaced from each other in an x-dimension of the AC inlet unit 100. The x-dimension is hereinafter referred to as a first dimension or a width of the AC inlet unit 100. The width of the AC inlet unit may be defined as a dimension in which the line pin 106, the ground pin 104, and the neutral pin 108 are displaced from each other and which increases in a direction from the line pin 106 to the ground pin 104 to the neutral pin 108. Accordingly, the line pin 106, the neutral pin 108, and the ground pin 104 are said to be laterally, i.e., sideways, displaced from each other.

In an example, as illustrated, the line pin 106 and the neutral pin 108 may each be displaced from the ground pin 104 in a z-dimension of the AC inlet unit 100. The z-dimension is hereinafter referred to as a second dimension or a height of the AC inlet unit 100. The height of the AC inlet unit 100 may be defined as a dimension of the AC inlet unit 100 in which the line pin 106 and the neutral pin 108 are each displaced from the ground pin 104 and which increases in a direction from the line pin 106/neutral pin 108 to the ground pin 104. Accordingly, the ground pin 104 may be said to be disposed at a greater height than the line pin 106 and the neutral pin 108, as illustrated.

The height and the width of the AC inlet unit 100 may be measured from a point that is at the same height as the bottommost point of the AC inlet unit 100 and that is at the same width as the leftmost point of the AC inlet unit 100. Such a point may be referred to as an origin 201.

The line pin 106, the neutral pin 108, and the ground pin 104 extend along a y-dimension, from the front of the socket 102 to behind the socket 102, as illustrated. The y-dimension may be referred to as a third dimension of the AC inlet unit 100 or a length of the AC inlet unit 100. The length of the AC inlet unit 100 may be also measured from the origin 201. Accordingly, the origin 201 may also be the front-most point of the AC inlet unit 100, i.e., from where the AC inlet unit 100 starts extending in the length dimension.

Each pin of the AC inlet unit 100 may extend in the third dimension from the front of the socket 102 to behind the socket 102 and be connected to a lead. For example, the ground pin 104 has a ground lead 202 connected to it behind the socket 102. Similarly, the line pin 106 may have the line lead 110 connected to it and the neutral pin 108 may have the neutral lead 112 connected to it behind the socket 102. The leads 202, 110, and 112 may extend further in the third dimension of the AC inlet unit 100 and may connect to another component (not shown in FIG. 2).

In an example, the ground pin 104 and the line pin 106 are 2.5 mm apart from each other and the ground pin 104 and the neutral pin 108 are 2.5 mm apart from each other. The distance between two entities, such as pins and leads, refers to a distance between their respective central axes, the central axis being the axis that extends along the length of the pins, i.e., in the third dimension. As will be understood, the distance between two axes is the length of the shortest line between the two axes. Further, the distance between two entities in a dimension may be referred to as a projection of the distance between the two entities in that dimension.

In an implementation, the ground lead 202 is disposed farther from the ground pin 104 in the first dimension than in the second dimension. For example, the ground lead 202 may be disposed sideways of the ground pin 104, as illustrated, and at a height that is slightly above or below the ground pin 104. Similarly, the line lead 110 can be disposed farther from the line pin 106 in the first dimension than in the second dimension. Further, the neutral lead 112 can be disposed farther from the neutral pin 108 in the first dimension than in the second dimension. For example, the line lead 110 can be disposed sideways from the line pin 106 and the neutral lead 112 can be disposed sideways from the neutral pin 108.

Each pin of the AC inlet unit 100 can be connected to its corresponding lead through a connector. For example, the ground pin 104 is connected to the ground lead 202 through a ground connector 204. Further, the second pin can be connected to the second lead through a second connector. For example, the line pin 106 is connected to the line lead 110, and the neutral pin 108 is connected to the neutral lead 112 through a line connector 206 and a neutral connector 208, respectively. Each connector extends in the second dimension and, the first dimension between its corresponding pin and the lead. Since the leads may be disposed farther from their corresponding pins in the first dimension than in the second dimension, the connectors may also have a greater length in the first dimension than in the second dimension. In an example, each of the ground connector 204, the line connector 206, and the neutral connector 208 is substantially L-shaped, as illustrated,

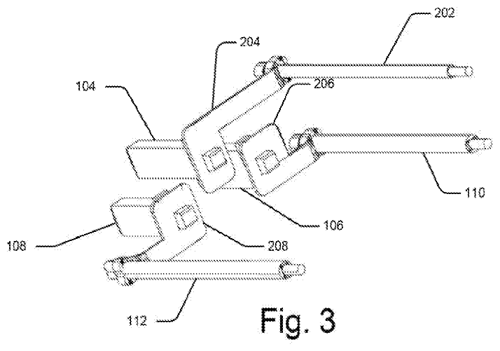

FIG. 3 illustrates the pins, leads, and connectors of the AC inlet unit 100 as viewed from behind the socket 102, according to an example implementation of the present subject matter. Here, the socket 102 is removed to clearly illustrate the connections between the pins and the leads through the connectors.

As illustrated, the ground pin 104, the line pin 106, and the neutral pin 108 extend in the third dimension of the AC inlet unit 100 and are connected, to their corresponding leads through connectors 204, 206, and 208, respectively. Further, the ground lead 202, the line lead 110, and the neutral lead 112 also extend in the third dimension of the AC inlet unit 100.

Although FIGS. 2 and 3 have been explained with reference to a C14 inlet unit, the AC inlet unit 100 may be any other type of AC inlet unit as well, such as a C6 inlet unit, C16 inlet unit, C16A inlet unit, C20 inlet unit, and C22 inlet unit.

As explained earlier, the ground lead 202 may be disposed farther from the ground pin 104 in the first dimension than the second dimension. For instance, the ground lead 202 is positioned sideways from the ground pin 104, instead of right above the ground pin 104. Similarly, the line lead 110 and the neutral lead 112 may be disposed farther from their corresponding pins in the first dimension than in the second dimension, such as, by positioning the line lead 110 and the neutral lead 112 sideways from the line pin 106 and the neutral pin 108, respectively. This can reduce the height of the AC inlet unit 100. Consequently, the height of a device including the AC inlet unit 100, such as a power adapter, can be reduced. Additionally, as the leads are moved away in the first dimension from the pins, their positions still comply with safety standards in terms of maintaining the distance between the leads and ensuring that the ends of the leads do not overlap with the socket. A power adapter according to an example implementation of the present subject matter is explained with reference to FIG. 4.

FIG. 4 illustrates a power adapter 400, according to an example implementation of the present subject matter. The power adapter 400 can be, for example, a power adapter for a laptop, desktop, or the like. The power adapter 400 includes the AC inlet unit 100, which, in turn, includes the socket 102, the ground pin 104, and the second pin, each disposed in the socket 102. In an example, the socket 102 may be integrated with a cover 402 of the power adapter 400.

As mentioned earlier, the second pin can be the line pin 106 or the neutral pin 108. In addition, the power adapter 400 can include a third pin. In an example where the second pin is the line pin 106, the third pin is the neutral pin 108. Contrarily, when the second pin is the neutral pin 106, the third pin is the line pin 106. The ground pin 104, the second pin, and the third pin are disposed in the socket 102. The ground pin 104 may be disposed at a greater height than the second pin. For example, as explained earlier, the ground pin 104 may be disposed above the line pin 106 and the neutral pin 108. Further, the ground pin 104, the line pin 106, and the neutral pin 108 may be laterally displaced from each other.

The power adapter 400 further includes a lead connected to the second pin, also referred to as a second lead. The second lead can be, for example, the line lead 110 or the neutral lead 112. A lead may also be connected to the third pin. This lead may be referred to as a third lead, and may be the neutral lead 112 or the line lead 110. Further, the power adapter 400 can include the ground lead 202, connected to the ground pin 104. The second lead, third lead, and ground lead 202 are disposed outside of the socket 102, as illustrated.

In an example, the second lead is disposed at a lower height than the ground pin 104. Further, the third lead may also be disposed at a lower height than the ground pin 104. For example, as illustrated, the line lead 110 and the neutral lead 112 are disposed below the ground pin 104.

The position of the second lead, i.e., the line, lead 110 or the neutral lead 112, below the ground pin 104 enables positioning of the ground lead 202 sideways of the ground pin 104, instead of right above the ground pin 104. Therefore, the top of the cover 402 of the power adapter 400 can be positioned closer to the top of the AC inlet unit 100 and yet maintain an adequate clearance with the leads and pins to comply with safety standards. Thus, such a positioning of the leads enables reducing the height of the power adapter 400. In an example when the AC inlet unit 100 is a C14 inlet unit, the positioning of the leads according to the present subject matter reduces the height H of the power adapter 400 to 23 mm from an earlier height of 25.4 mm. In other examples, depending upon the standards to be complied with and spacing to be provisioned for tooling, the height, of the power adapter 400 can be further reduced.

It is to be understood that, while the overall height of the power adapter 400 is reduced, the size of the socket 102 and the horizontal and vertical spacing between the pins are maintained as per the standards, such as the IEC 60320 standard. Therefore, the present subject matter, while making the power adapter 400 compact, also ensures that the power adapter 400 is compliant with standards.

In an example, the power adapter 400 has a form factor of a tube. The length of the tube may extend in a direction along the length of the leads, i.e., in the length or third dimension of the AC inlet unit 100,

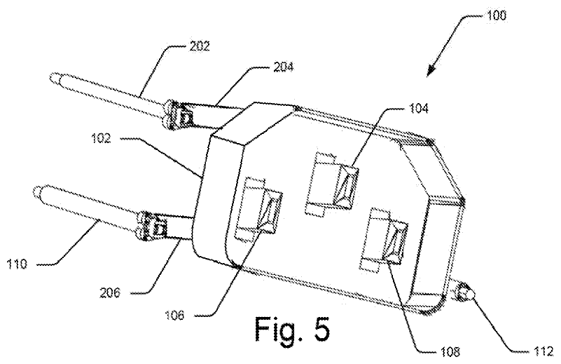

FIG. 5 illustrates a perspective view of the AC inlet unit 100, according to an example implementation of the present subject matter. As explained earlier, the power supply cord can be received from the front side of the socket 102. Further, the AC inlet unit 100 can include the ground pin 104 and the second pin, such as the line pin 106 or neutral pin 108. The ground pin 104 can have the ground lead 202 connected to it. In an example, the ground lead 202 is disposed farther from the ground pin 104 as compared to the second pin. For example, the ground lead 202 may be nearer to the line pin 106 than to the ground pin 104.

The present subject matter reduces the height of the AC inlet unit. Therefore, the present subject matter makes an equipment, such as a power adapter, including the AC inlet unit more compact. While making the equipment compact, the present subject matter enables them to be compliant with standards, such as IEC 60320. Further, techniques of the present subject matter can be used for different types of AC inlet units, such as C14 inlet unit, C6 inlet unit, C16 inlet unit, C16A inlet unit, C20 inlet unit, and C22 inlet unit.

Although implementations of lead disposal in AC inlet units have been described in language specific to structural features and/or methods, it is to be understood that the present subject matter is not necessarily limited to the specific features or methods described. Rather, the specific features and methods are disclosed and explained as example implementations.

We claim:

1. An Alternating Current (AC) inlet unit comprising:
a socket to receive a power supply cord;
a ground pin and a second pin, each disposed in the socket; and
a lead connected to the second pin, wherein the lead is disposed farther from the ground pin as compared to the second pin.

2. The AC inlet unit of claim 1, wherein the AC inlet unit is one of a C14 inlet unit, a C6 inlet unit, a C16 inlet unit, a C16A inlet unit, a C20 inlet unit, and a C22 inlet unit.

3. The AC inlet unit of claim 1, wherein the second pin is one of a line pin and a neutral pin.

4. The AC inlet unit of claim 1, comprising:
a ground lead connected to the ground pin, wherein the ground lead is disposed farther from the ground pin as compared to the second pin.

5. A power adapter for a computing device, the power adapter comprising:
an Alternating Current (AC) inlet unit comprising:
a socket to receive a power supply cord;
a ground pin and a second pin, each disposed in the socket, wherein the ground pin is disposed at a greater height than the second pin; and
a lead connected to the second pin, the lead being disposed outside the socket, wherein the lead is disposed at a lower height than the ground pin.

6. The power adapter of claim 5, wherein the second pin is ne of a line pin and a neutral pin.

7. The power adapter of claim 5, wherein the power adapter has a form factor of a tube.

8. The power adapter of dal third pin, wherein the third pin is one of a line pin and a neutral pin.

9. The power adapter of claim 7, comprising a ground lead connected to the ground pin, wherein the ground lead is laterally displaced from the ground pin.

10. An Alternating Current (AC) inlet unit for a power adapter of a computing, device, the AC inlet unit comprising:
a socket to receive a power supply cord;
a line pin, a neutral pin, and a ground pin, each disposed in the socket, wherein the line pin, the neutral pin, and the ground pin are displaced from each other in a first dimension of the AC inlet unit and wherein the line pin and the neutral pin are each displaced from the ground pin in a second dimension of the AC inlet unit; and
a ground lead connected to the ground pin, wherein the ground lead is disposed farther from the ground pin in the first dimension than in the second dimension.

11. The AC inlet unit of claim 10, wherein the first dimension is a width and the second dimension is a height of the AC inlet unit.

12. The AC inlet unit of claim 10, comprising a ground connector connecting the ground lead to the ground pin, wherein the ground connector is substantially L-shaped.

13. The AC inlet unit of claim 11, wherein the ground, pin is disposed at a greater height than the line pin and the neutral pin.

14. The AC inlet of claim 10, comprising a line lead connected to the line pin and a neutral lead connected to the neutral pin, wherein the line lead, is farther from the line pin in the first dimension than in the second dimension, and wherein the neutral lead is farther from the neutral pin in the first dimension than in the second dimension.

15. The AC inlet unit of claim 10, wherein the AC inlet unit is one of a C14 inlet unit, a C6 inlet unit, a C16 inlet unit, a C16A inlet unit, a C20 inlet unit, and a C22 inlet unit.
